(19) United States
(12) Patent Application Publication
(10) Pub. No.: US 2017/0353610 A1
(43) Pub. Date: Dec. 7, 2017

(54) BANDWIDTH-SHARING, INTELLIGENT NETWORK SWITCHING SYSTEM

(71) Applicant: Zhenkun Wang, Ashburn, VA (US)

(72) Inventor: Zhenkun Wang, Ashburn, VA (US)

(21) Appl. No.: 15/232,926

(22) Filed: Aug. 10, 2016

(30) Foreign Application Priority Data
Jun. 4, 2016 (CN) 201620531003.2

(51) Int. Cl. H04M 15/00; H04W 60/00; H04W 4/24; H04W 12/06; H04W 76/02; H04W 84/12

(52) U.S. Cl. CPC H04M 15/90; H04W 12/06; H04W 76/02; H04W 60/00; H04M 15/61; H04W 4/24; H04M 15/8214; H04W 84/12

(57) ABSTRACT

The present invention provides a bandwidth-sharing, intelligent network switching system, wherein the system comprises a control processing unit, a network sharing user device, and a network user device. The control processing unit is connected to a third-party payment system, a location search module, a WiFi hotspot search module, bandwidth analysis module, and an authentication module. The control processing unit is further connected to the network sharing user device and the network user device. The network sharing user device shares network access with the network user device via the control processing unit, sets a price for bandwidth, and charges the network user device the price for the shared network access.

### CROSS REFERENCE TO RELATED APPLICATION

This application claims priority to Chinese Patent Application No. 201620531003.2 filed in the Chinese Patent Office on Jun. 4, 2016, the entire content of which is incorporated herein by reference.

### BACKGROUND OF THE INVENTION

With the rapid development of mobile Internet technology, mobile data traffic has soared, and according to some estimates, traffic generated by mobile devices will grow by nearly 11-fold in the next five years to occupy 55% of global internet traffic. In order to manage the increase in bandwidth usage, many network operators or internet service providers enforce bandwidth caps on network users and use pricing tiers to regulate monthly bandwidth usage. As a result, many users either are limited by their bandwidth cap, or pay for more bandwidth than they use in any given month.

Network users (such as mobile clients, home broadband users, and other internet users) have had very limited options in regards to sourcing internet access. The conventional internet service provider model dictates that network users accept network service from their internet service provider and accept the associated fees and bandwidth limits set by the operator. For network operators and internet service providers, they are faced with the challenge of expanding their physical network with by constructing further infrastructure to support remote areas and enlarging population centers.

It is then a goal of the present invention to provide a system for individual network users to share and monetize excess bandwidth with other individual network users. By doing so, network users are no longer beholden to limited pricing and service options, and have greater flexibility to choose their provider and service according to their individual pricing and bandwidth needs. This also enables network operators to increase the reach of their existing networks, by allowing individual network users to act as part of the network infrastructure.

### BRIEF SUMMARY OF THE INVENTION

It is an object of the invention to provide a bandwidth-sharing, intelligent network switching system.

According to an embodiment of the present invention, a bandwidth-sharing, intelligent network switching system is provided, wherein the system comprises a control processing unit, a network sharing user device, and a network user device. The control processing unit is connected to a third-party payment system, a location search module, a Wi-Fi hotspot search module, bandwidth analysis module, and an authentication module. The control processing unit is further connected to the network sharing user device and the network user device.

The network sharing user device comprises a registration module, an authentication module, a payment module, a network sharing module, and a monitoring control unit, which are connected to the control processing unit.

The network user device comprises a search module, a price module, a filtering module, and an account management module, which are connected to the control processing unit.

In an embodiment, the search module comprises a price filtering module and a distance filtering module.

One of the present invention's embodies provides a method implemented as a software system including a downloadable software; the software provides a platform for purchasing and selling bandwidth. Such platform provides a market place for those, who do not need great bandwidth and unwilling to be locked into any annual service contract, to purchase bandwidth as needed basis. For instance, the participating members can reduce the network connection cost via the instant invention by purchasing bandwidth from other member's residential household Wi-Fi or cellular network hotspot. As a seller, seller has the flexibility to configure particular time slots for providing available bandwidth to other interested members. Sellers can also terminate the availability of the bandwidth to ensure their own usage. For cellular bandwidth sellers, sellers can prioritize own bandwidth usage, and only make the remaining bandwidth available to other members.

It is to be understood that both the forgoing general description and the following detailed description are exemplary and explanatory and are not restrictive of the invention, as claimed.

### BRIEF DESCRIPTION OF THE SEVERAL VIEWS OF THE DRAWINGS

The above embodiments become more readily apparent to those ordinarily skilled in the art after reviewing the following detailed description and accompanying drawings, in which:

FIG. 1 is a schematic diagram of the bandwidth-sharing, intelligent network switching system.

### DETAILED DESCRIPTION OF THE INVENTION

Aspects, features and advantages of several exemplary embodiments of the present invention will become better understood with regard to the following description in connection with the accompanying drawings. It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute terms, such as, for example, “will,” “will not,” “shall,” “shall not” “must,” and “must not,” are not meant to limit the scope of the present invention as the embodiments disclosed herein are merely exemplary.

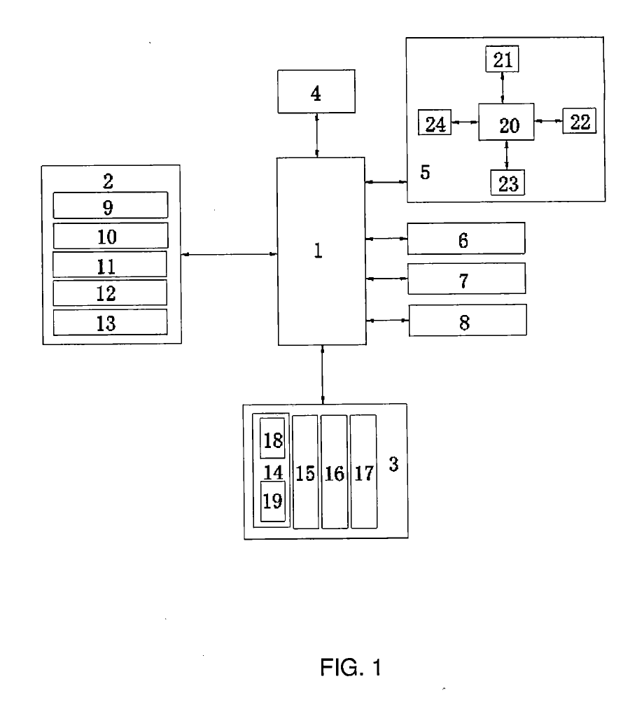

FIG. 1 is an exemplary embodiment of the bandwidth-sharing, intelligent network switching system, comprising a control processing unit (CPU) 1, a network sharing user device 2, and a network user device 3. The control processing unit 1 is connected to a third-party payment system 4, a location module 5, a WiFi hotspot search module 6, bandwidth analysis module 7, and an authentication module 8.

In this embodiment, the modules of the control processing unit 1 can be implemented using a processor and non-transitory storage media, or firmware associated with a processor. The location search module 5 can be implemented using a global positioning system (GPS) circuit, and the WiFi hotspot search module 6 can be implemented using an antenna and WiFi circuit.

In this embodiment, the control processing unit 1 is connected to the network sharing user device 2 and the network user device 3. The control processing unit 1 can be connected wirelessly or wired to the network sharing user device 2. The control processing unit 1 may alternatively be integrated as a firmware or hardware in the network sharing user device 2. The network sharing user device 2 may be a cellular phone, computer, residential home network, or similar internet capable device. The network user device 3 may be a cellular phone, computer, or other internet capable device.

The network sharing user device 2 provides internet access to the network user device 3 after successfully authentication and payment via the control processing unit 1. In this embodiment, the network sharing user device 2 comprises a registration module 9, an authentication module 10, a payment module 11, a network sharing module 12, and a monitoring control unit 13, which are connected to the control processing unit 1.

In this embodiment, the registration module 9, authentication module 10, payment module 11, network sharing module 12, and monitoring control unit 13 can be implemented using a processor and non-transitory storage media, or firmware. The registration module 9 is provided to receive and process user account information. The user account information may be for a new user, or an existing user of the system. The user account information may comprise a user name, address, and/or billing information. The authentication module 10 is provided to authenticate the credentials of a connecting user according to the user account information. The authentication module 10 can also retrieve real billing information such as names and addresses. After the credentials are verified, the payment module 11 is provided to retrieve a stored payment method such as a credit or debit card according to the user account, to accept a new payment method to the user account, or to retrieve a stored account balance associated with the user account. The network sharing module 12 provides network access via the control processing unit 1 to the network user device 3. The monitoring control unit 13 measures how much network bandwidth has been used by the connected network user device 3 and also calculates the cost or available balance according to the used network bandwidth for the connected network user device 3. The monitoring control unit 13 sends periodic usage information to the network user device 3 via the control processing unit 1.

The payment module 11 is also used to set the price per bandwidth for shared network usage. The price per bandwidth can be set by the user or by default. The price per bandwidth can be some dollar amount per megabyte or similar The network sharing user device 2 can also set a maximum amount of bandwidth to share. The payment module 11 receives payment information and transmits it to the third party payment system 4 via the control processing unit 1.

The network user device 3 comprises a search module 14, a price module 15, a filtering module 16, and an account management module 17, which are connected to the control processing unit 1. In an embodiment, the search module 14 comprises a price filtering module 18 and distance filtering module 19. The search module 14 is provided to allow the network user device 3 to locate a nearby network sharing user device 2. The search module 14 produces a list of all nearby network sharing devices. The list can also include nearby WiFi hotspots. The price filtering module 18 removes all sharing devices above a certain price per bandwidth, and the distance filtering module 19 removes all sharing devices above a certain distance. The filtered price per bandwidth and distance can be set by a user or can be set to a default value. The search module 14 sends the distance information and price per bandwidth information of the nearby network sharing user device 2 to the display of the network user device 3. The network user device 3 chooses which network sharing user device 2 to connect to, and can send user account information and payment information to the network sharing user device 2. The network user device 3 can choose which network sharing user device 2 to connect to according to price, speed, signal quality, and distance. The network user device 3 can automatically switch to a different network sharing user device 2 if a cheaper, faster, or better connection is available.

The location module 5 comprises a central processing unit (CPU) 20 connected to a position locating unit 21, a location searching unit 22, and a mapping unit 23.

The present invention provides a platform for un-used bandwidth to be available to others. Such that it reduces the financial burden for those have entered annual service contract; and it further reduces unfair competition among service providers. If any household has a Wi-Fi idling, such Wi-Fi connections can be sold/shared via the instant invention, which reduces the cost of the Wi-Fi connection for all the participating members (both seller and purchaser). As for purchaser, purchaser can download the software to locate and to purchase the best performance bandwidth at the lowest price. Hence, the instant invention provides a method to connect to a network without routers, and purchaser only purchase the amount of bandwidth as needed. Further, the instant invention provides a third party platform for tracking available bandwidths in each area and tracking each purchasing transaction. Sellers and purchasers do not need to directly communicate or negotiate with each other; all transactions are handled and monitored by the central server of the platform; and only registered and verified members can conduct transactions with each other.

As the member base increases, the number of bandwidth selling/purchasing transactions will also increase. The instant invention provides the following advantages: 1. the usage of existing routers will increase; 2. the operation cost for the existing network users will reduce, and it also prevent any industrial service providers to monopoly the market; 3. the strength of the network connectivity will increase as the number of the participating Wi-Fi providers increases; 4. the coverage of the network increases; the instant invention extends the network coverage to anywhere the participating members are.

The foregoing description of the preferred embodiments is presented for purposes of illustration and description. It is not intended to be exhaustive or limit the invention to the precise form of the exemplary embodiments disclosed. Many modifications and variations will be apparent to those of ordinary skill in the art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims.

What is claimed is:

1. A bandwidth-sharing, intelligent network switching system, comprising:
a control processing unit connected to a third-party payment system, a location search module, a WiFi hotspot search module, a bandwidth analysis module, and a first authentication module;
a network sharing user device connected to said control processing unit, and configured to set a price for bandwidth, set a bandwidth cap, receive a user account information, receive a payment information, authenticate a user account information, and share network access to the control processing unit according to the price for bandwidth and bandwidth cap; and
a network user device connected to said control processing unit, configured to receive said network access from the control processing unit, send said user account information, and send said payment information.

2. The system of claim 1, wherein the network sharing user device comprises:
a registration module, configured to receive said user account information;
a second authentication module, configured to authenticate said account information;
a payment module, configured to receive said payment information, set said price for bandwidth, and set said bandwidth cap;
a network sharing module, configured to share said network access to the control processing unit; and
a monitoring control unit, configured to monitor an amount of bandwidth used by said network user device, calculate a cost for said amount of bandwidth according to said price for bandwidth, and periodically send a usage information to said network user device according to said cost and said amount of bandwidth;
wherein, the payment module charges said payment information according to said cost via the third-party payment system.

3. The system of claim 1, wherein the network user device comprises:
a search module, configured to locate said network sharing user device from a plurality of network sharing user devices according to a maximum distance and a maximum price per bandwidth; and
an account management module, configured to store said user account information, and said payment information.
